(19) United States
(12) Patent Application Publication
(10) Pub. No.: US 2020/0115124 A1
(43) Pub. Date: Apr. 16, 2020

(54) MIRROR UNIT TRANSPORT DEVICE AND METHOD FOR ASSEMBLING IN A SOLAR FIELD

(71) Applicant: FRENELL GmbH, Karlsruhe (DE)

(72) Inventor: Max MERTINS, Freiburg (DE)

(73) Assignee: FRENELL GmbH, Karlsruhe (DE)

(21) Appl. No.: 16/499,892

(22) PCT Filed: Apr. 5, 2017
(86) PCT No.: PCT/DE2017/100263

§ 371 Date: Oct. 1, 2019

(51) Int. Cl. B65D 71/00; B65D 85/30; F24S 23/77; F24S 80/00

(52) U.S. Cl. CPC B65D 71/0088; B65D 85/30; F24S 2023/872; F24S 80/00; F24S 23/77

(57) ABSTRACT

To provide an efficient transportation possibility for mirror units which is reliable and cost-effective in equal measure, end panels are first attached to the end faces of the mirror units such that several of the end panels complement one another so as to form a transport device with which the mirror units can be assembled in order to form a transport unit. The end panels form a support frame, which can be anchored in base rails, in a manner similar to a jigsaw puzzle, the support frame allowing a secure and simple transport of multiple mirror units on a narrow space.

The present invention relates to a transport apparatus comprising at least one end panel for attachment to an end face of a mirror unit, wherein the end panel has a first longitudinal edge having engagement means and a second longitudinal edge having counter-engagement means, and the engagement means of the first longitudinal edge interact with the counter-engagement means of the second longitudinal edge of a further end panel having the same construction, and to a transport method for mirror units for installation in a solar field.

A comparable transport device is already known from JP2004207667A, wherein this is a transport device for photovoltaic elements, which, however, are formed in completely planar manner and possess transport characteristics that are different from those of mirror units.

Also, temporary placement of end elements for simplification of goods transport is known from EP0924137A1, for example, where an end element allows a vertical connection with adjacent elements. In order to equip a solar field with mirror units, a great number of these mirror units is required, in particular in the case of a solar field to be built on a power plant scale. For example, the design of a solar-thermal power plant provides that an absorber is placed on a stand in an elevated position, and that mirror units are positioned on both sides of this absorber, which units concentrate the incident sunlight onto the absorber. These absorbers can easily assume lengths of several hundred meters, and are themselves present in great numbers in such a solar field, so that many kilometers of absorber pipes occur, around which multiple rows of mirror units are positioned on both sides.

The mirror units themselves have a housing that can possess a trapezoid cross-section, for example, which takes up space. This is necessary in order to prevent the mirrors from twisting, which would cause imprecise deflection of the incident sunlight. Due to this housing shape, greater effort is required to package the individual mirrors, so as to package then for transport to an installation site. In order to protect the installed mirrors against damage, for one thing, which damage would impair the reflections and thereby directly influence the energy yield of the power plant, but on the other hand to allow the best possible utilization of space during transport, it has been necessary until now to package the mirror units individually or in small groups and to stack the individual packaging units one on top of the other so that transport is made possible. The transport material that occurs for this purpose, for example wooden crates and the like, subsequently must be transported back from the installation site, or is passed to recycling on location. In addition to the material costs that occur in this regard, it must be added that the transport packaging also has to be transported and that its weight also causes significant transport costs.

Against this background, the present invention is based on the task of proposing a transport apparatus as well as a method for transport of mirror units, which reduces the transport costs for mirror units for installation in a solar field, simultaneously facilitates handling of the mirror units, and reduces the waste material that occurs in connection with transport.

This is accomplished by means of a transport apparatus for mirror units in accordance with the characteristics of claim 1 and by means of a method for transport of mirror units in accordance with the characteristics of the independent claim 7. Further practical embodiments of the transport apparatus can be derived from the dependent claims 2-6, and practical embodiments of the method can be derived from the dependent claims 8-12.

According to the invention, it is proposed that a transport apparatus for mirror units comprises at least one end panel, which can be attached to an end face of a mirror unit. In this regard, the end panel has a first longitudinal edge having engagement means, as well as a second longitudinal edge having counter-engagement means, so that the end panels can be stacked one on top of the other, wherein the adjacent end panels can be brought into shape fit and/or into force fit with one another with their engagement means and/or with counter-engagement means that are brought into contact with them. Such a design makes it possible to provide part of the transport apparatus exclusively at the end faces, wherein due to the stacking of the end panels that ultimately takes place, a distance is defined between the mirror units connected with the panels, so that reciprocal contacting of the mirror units is thereby prevented. Thus, a safety distance between the mirror units is provided between the end panels that are stacked one on top of the other, so that additional securing between the mirror units is not required. Therefore the use of material and the work effort in packaging the mirror units are reduced to affixing the end panels to the end faces of the mirror units; the mirror units prepared for transport in this way merely have to be stacked one on top of the other, with reciprocal contacting of the end panels.

In particular, it is provided, in this regard, that the engagement means of the first longitudinal edge of the end panel comprise a back-offset. This back-offset ensures that part of every mirror unit is not covered by the end panel. This non-covered part of the end face of the mirror unit is, however, covered by the counter-engagement means of the second longitudinal edge of an adjacent end panel having the same construction, which engages at this location, preferably with shape fit. By means of this design, lateral slipping of the mirror units is prevented, since the mirror unit that lies underneath, in each instance, holds the mirror unit that lies above it in place. In this way, therefore, fixation in the entire plane of the mirror units takes place, as does support in a downward direction, so that removal of a mirror unit is only possible in an upward direction. To some advantage, the engagement means and counter-engagement means do not provide for hindering removal in an upward direction.

Furthermore, the end panel can have two upright edges having engagement means, which allow a lateral connection with adjacent end panels of the same type. In this regard, it is to some advantage that the engagement means can be structured in such a manner that they interact with similar engagement means of an end panel that has preferably been rotated by 180°, so that it is possible to arrange mirror units that are offset by 180°, in each instance, next to one another and to connect them laterally. By means of this alternate placement, it is possible, specifically in the case of a trapezoid cross-section of the mirror units, to arrangement to overlap, so as to achieve a further effect in this regard, by means of saving space. In this way, more mirror units can be accommodated in the same amount of space than if they were arranged next to one another, with an orientation in the same direction.

For better handling of the mirror units, rotation axles or holders for such rotation axles are assigned to their end panels, and can be used to bring about rotation of the overall arrangement of end panels and mirror unit, if necessary about the rotation axle. Within the scope of conveying, for example by means of a lifting apparatus, a rotational movement can be superimposed on the lifting movement in this way, so that each mirror unit can be inserted in a correct position of rotation.

For further simplified transport, the transport apparatus can furthermore comprise a base rail, which is set directly on the ground and into which the lowermost end panels can be inserted directly. For this purpose, the base rail has a longitudinal slot, into which the end panels are inserted with their longitudinal edges. This makes it possible to lift a complete transport unit with the base rail, without having to fear collapse of the transport unit; in the longitudinal slot, the end panels are protected against slipping in the longitudinal direction of the mirror units. In a practical embodiment of the base rail, at least one engagement means and/or counter-engagement means can be provided, in particular in the longitudinal slot of the base rail, wherein these means are configured corresponding to the engagement means and counter-engagement means of the longitudinal edges, and function analogous to them. An engagement means of an end panel can thereby be inserted into a counter-engagement means of the base rail, and vice versa, a counter-engagement means of an end panel can be inserted into an engagement means of the base rail. Thereby secure holding of the lowermost layer of mirror units within a transport unit is guaranteed. Here, too, it is provided to arrange engagement means and counter-engagement means of the base rail in an alternating sequence, so that here, too, overlapping of the mirror units is made possible, in the case of a trapezoid cross-section, for example.

Furthermore, at least one of the two base rails used for a transport unit can have at least one rolling or sliding element assigned to it, so that the entire transport unit becomes movable by picking the transport unit up on one side, on a base rail that lies opposite the rolling or sliding element. For example, the transport unit can be lifted on one side, using a forklift truck, and can then be moved forward or backward, as desired, so as to move the entire unit without lifting it as a whole.

A transport unit compiled in such a manner can thereby be moved to the installation site as a whole, and can there be taken apart again by means of a crane apparatus. When taking the transport unit apart, it is to some advantage that the individual mirror units are brought down onto a support apparatus, on which the mirror units are supposed to be installed, directly from the transport unit. During the course of transport from the transport unit to the support apparatus, the respective mirror unit can be rotated about its rotation axle, if necessary, while it is hanging on the crane, so that it can be installed on the support apparatus with its mirror side facing upward. In this regard, it is advantageous if the support apparatus has a rail arrangement on which the mirror units can be moved along the support apparatus. In this way, it is possible to set the individual mirror units down at one end of the support apparatus and then to move them to their installation position by way of the rail arrangement. In this regard, it can be provided that the end panels are structured in such a manner that these can be moved in the rail arrangement, so that the respective end panels are only removed at the installation position, where the individual mirror units are attached to the supports provided for this purpose. Alternatively, however, it is also possible to free the mirror units of the end panels immediately after they are set down, and to bring them to their installation position using a carriage that can be moved on the rail arrangement. In a further embodiment of the latter possibility, a separate carriage can be provided for each mirror unit, which carriage is ultimately fixed in place at the installation position.

The present invention will be explained in greater detail in the following, using an exemplary embodiment.

The figures show:

FIG. 1 a detail of a mirror unit having a laterally mounted end panel, in a perspective representation at a slant from above,

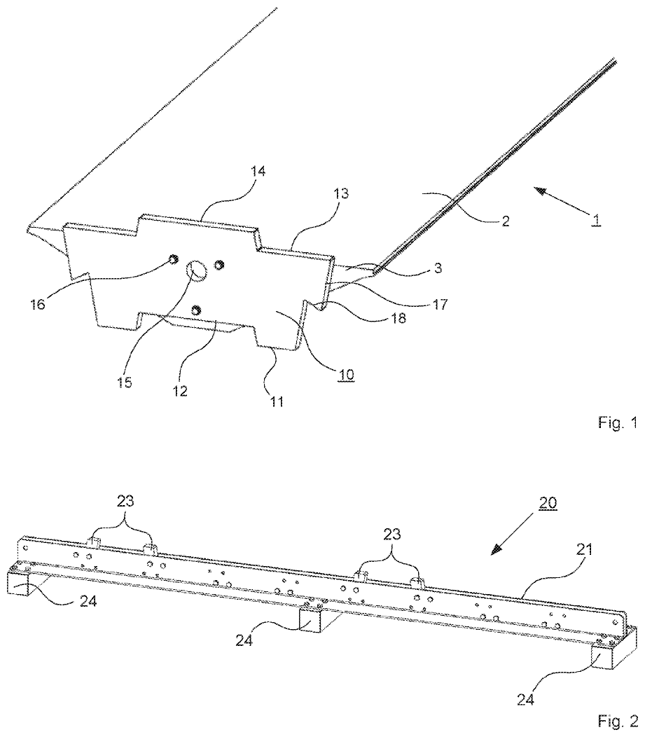

FIG. 2 a base rail in a perspective representation, at a slant from above,

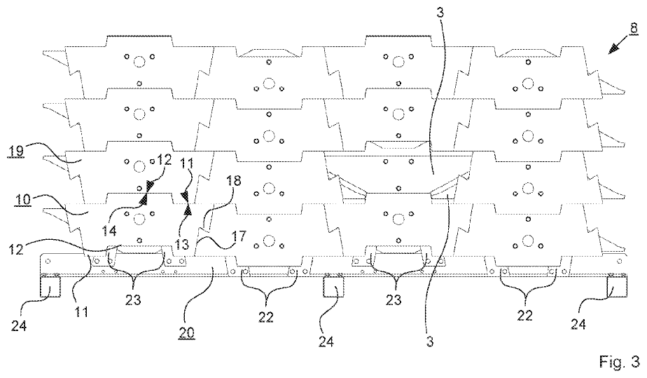

FIG. 3 a transport unit in a top view from the side, into the end panels used there, wherein one of the end panels is omitted, and the base rail is shown in its cross-sectional representation,

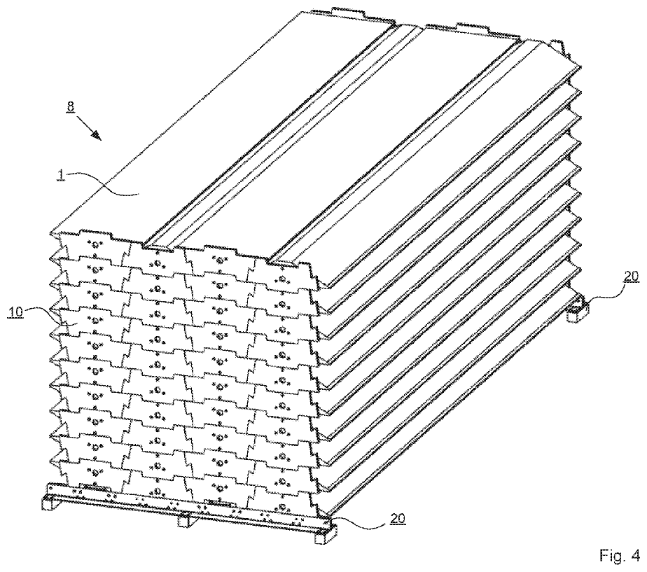

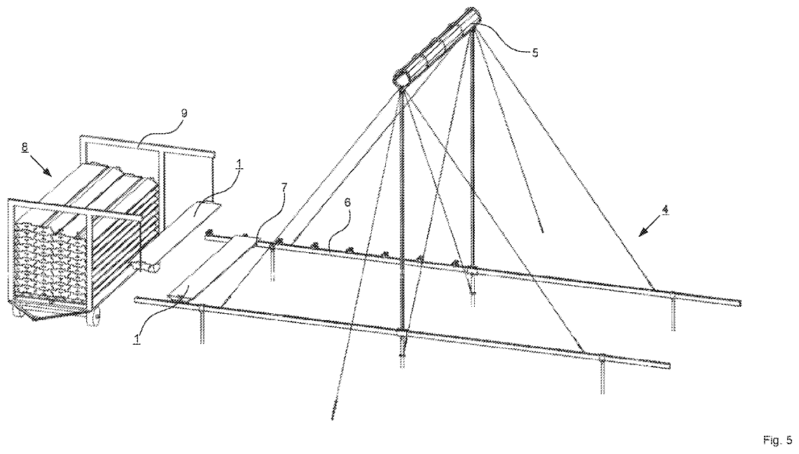

FIG. 4 a transport unit in a perspective representation at a slant from above, and

FIG. 5 a transport unit at the installation site, when setting mirror units down onto a support apparatus, also shown, in a solar field, in a perspective representation at a slant from above.

FIG. 1 shows a mirror unit 1, which consists essentially of a housing having a trapezoid cross-section and a mirror 2 attached to it. Only the end face 3 of the housing can be seen, in part, which projects beyond the edges of an end panel 10 attached to the end face 3. This projection is intentional, so as to achieve a counter-hold by means of adjacent end panels 19, wherein parts of the end panel 10 in turn project beyond the mirror unit 1, so as to allow contacting of adjacent mirror units, in turn. Thus, the end panel 10 first has a first longitudinal edge 11, which possesses a backward offset as an engagement means 12. A second longitudinal edge 13, which has a corresponding counter-engagement means 14 in the form of a projection, which, based on its shape, functions as a counter-part to the engagement means 12 on the first longitudinal edge 11, is provided opposite the first longitudinal edge 11. The end panel 10 is connected with the mirror unit 1 by way of a rotational fixation 16, and has a holder 15 into which a rotation axle for rotation of the mirror unit 1 along its longitudinal axis can be placed.

FIG. 2 shows a base rail 20, into which a lowermost layer of mirror units 1 can be inserted. Two of these base rails 20 are set up parallel to and offset from one another for this purpose, wherein the distance of the length of a mirror unit 1 should be provided between them. The base rail 20 shown has visible counter-engagement means 23, which engage into engagement means 12 of end panels 10 to be set onto them. Parts of the first longitudinal edge 11 are inserted into a longitudinal slot 21 of the base rail 20, while the counter-engagement means 23 engage into the engagement means 12 and thereby prevent displacement of the mirror unit 1 and of the end panel 10 connected with it in the longitudinal direction of the longitudinal slot 21. The delimitations of the longitudinal slot 21, on the other hand, prevent slipping transverse to the longitudinal slot 21, so that in this way, removing the lowermost layer of mirror units from the base rail 20 is only possible by means of lifting it.

Engagement means 22 arranged alternating with the counter-engagement means 23 are present but cannot be seen in FIG. 2, wherein mirror units rotated by 180° can be inserted into these engagement means 22, wherein in this case, the counter-engagement means 14 of their second longitudinal edges 13 can be inserted. The base rail 20 furthermore has stand elements 24, which can be provided with casters, if necessary.

FIG. 3 shows a possible transport unit 8, in the case of which into the base rail 20 shown, which is merely shown in a cross-section along the longitudinal slot 21, is filled with four mirror units, arranged alternately next to one another and rotated by 180°, as the lowermost layer. Each of the mirror units 1 inserted into the base rail 20 has three further mirror units 1 laid on top of it, wherein the end panels 10, 19 connected with them combine in the manner of a puzzle to form a wall of end panels 10, 19. In the drawing of FIG. 3, one of the end panels 10 is omitted for a better illustration, so that in this position, the reciprocal position of adjacent end faces 3 can be seen. Here, it can easily be perceived that mirror units 1 that are laterally adjacent can be arranged in such a manner, on the basis of their trapezoid cross-section, that the housings of the mirror units 1 overlap one another, so that tight packing of the mirror units 1 in the transport unit 8 can take place.

The base rail 20, mounted on the stand elements 24, has both engagement means 22 and counter-engagement means 23 in its longitudinal slot, as has already been mentioned. When filling the base rail 20 in the embodiment shown, first a mirror unit 1, with its mirror side facing downward, is laid into each of the existing engagement means 22, and, after all of the mirror units 1 that have been rotated by 180° and have their mirror side facing downward have been laid in place, the remaining spaces, with their counter-engagement means 23, are filled with mirror units 1, the mirror sides of which face upward. As a result, the engagement means 18 arranged on the upright edges 17 engage into one another and connect the respective end panels 10 laterally with one another. After completion of a lowermost layer of mirror units 1, the next layer is layered on top of it, wherein further end panels 19 having the same construction, adjacent one above the other, are oriented in the same orientation as the end panels 10 that lie underneath. The further end panel 19 has an engagement means 12 at its first longitudinal edge 11, which means engages into a counter-engagement means 14 on the second longitudinal edge 13 of the end panel 10 and thereby prevents displacement of the mirror unit 1 in the entire arrangement of the transport unit 8. As shown in the region of the omitted end panel, displacement in the viewing direction or in the direction out of the plane of the figure is effectively prevented by means of the overlap of the respective mirror units with their end faces 3 beyond the adjacent end panels 10, 19.

FIG. 4 shows a complete transport unit 8, consisting of a plurality of mirror units 1, which are arranged, alternately rotated by 180°, in layers, on a total of two base rails 20. It can be seen that the end panels 10, which are connected with the mirror units 1, in each instance, represent a side wall that hold the mirror units 1 in position between the two base rails 20. Disassembly of this transport unit 8 is thereby only made possible by means of removal of the individual layers, taking place one after the other, from top to bottom. Transporting of the transport unit 8 can take place, for example, in that a forklift truck moves its fork in between stand elements 24 of the base rail 20, on one side, lifts this side, and brings about a movement of the transport unit 8 by way of casters arranged on the second base rail 20.

FIG. 5, finally, shows a support apparatus 4, on which the mirror units 1 are supposed to be installed at the installation site. For this purpose, as has already been presented, the mirror units 1 are delivered using a crane cart, and unloaded, and set down onto the support apparatus 4, in each instance, in an end position. The mirror units 1, which have already been freed of the end panel 10 in this position, are moved to their ultimate installation position by means of a carriage 7, where they are released from the carriage and connected in the installation position using their rotational joints, in situ. In the installation position, which they reach by way of displacement of the carriage 7 along a rail arrangement 6, they can be oriented in such a manner, if necessary, that the incident sunlight first hits the mirrors of the mirror units 1 and then an absorber 5 arranged elevated above the support apparatus 4.

What has been described above is therefore a transport apparatus and a corresponding method, which allows effective transport of mirror units, for which a minimum of transport packaging is required, which packaging can furthermore easily be re-used.

### REFERENCE SYMBOL LIST

1 mirror unit
2 mirror
3 end face
4 support apparatus
5 absorber
6 rail arrangement
7 carriage
8 transport unit
9 crane cart
10 end panel
11 first longitudinal edge
12 engagement means
13 second longitudinal edge
14 counter-engagement means
15 holder
16 rotation fixation
17 upright edge
18 engagement means
19 further end panel
20 base rail
21 longitudinal slot
22 engagement means
23 counter-engagement means
24 stand element

1. A transport apparatus for mirror units for installation in a solar field, comprising at least one end panel (10) for attachment to an end face (3) of a mirror unit (1), wherein the end panel (10) has a first longitudinal edge (11) having engagement means (12) and a second longitudinal edge (13) having counter-engagement means (14), and the engagement means (12) of the first longitudinal edge (11) interact with the counter-engagement means (14) of the second longitudinal edge (13) of a further end panel (19) having the same construction, wherein the engagement means (12) of the first longitudinal edge (11) of the end panel (10) comprise a back-offset, which ensures that part of the end face (3) of the mirror unit (1) remains not covered by the end panel (10), and into which the counter-engagement means (14) of the second longitudinal edge (13) of an adjacent end panel (19) having the same construction engage and cover the non-covered part of the end face (3) of the mirror unit (1), wherein the end panel (10) has two upright edges (17) having engagement means (18), which interact with similar engagement means (18) of a further end panel (19) having the same construction and rotated by 180°.

2. The transport apparatus according to claim 1, wherein a rotation axle or a holder (15) for a rotation axle is assigned to the end panel (10).

3. The transport apparatus according to claim 1, further comprising at least one base rail (20) having a longitudinal slot (21) for holding the longitudinal edges (11, 13) of at least one end panel (10), wherein the base rail (20) is elevated on at least one stand element (24).

4. The transport apparatus according to claim 3, wherein engagement means (22) and/or counter-engagement means (23) for force-fit holding of first and/or second longitudinal edges (11, 13) are arranged in the longitudinal slot (21).

5. The transport apparatus according to claim 4, wherein engagement means (22) and counter-engagement means (23) are arranged in the longitudinal slot (21) in an alternating sequence.

6. The transport apparatus according to claim 3, wherein at least one rolling or sliding element is assigned to the stand element (24).

7. A method for transport of mirror units for installation in a solar field, wherein first, a transport unit (8) is formed from a plurality of mirror units (1), this transport unit (8) is brought to an installation site, and the transport unit (8) is disassembled at the installation site, wherein the individual mirror units (1) are removed and fixed in place in an installation position, wherein the mirror units (1) have an end panel (10) assigned to them on their face ends (3), in each instance, in torque-proof manner, to form the transport unit (8), wherein the end panel (10) has a first longitudinal edge (11) having engagement means (12) and a second longitudinal edge (13) having counter-engagement means (14), and multiple mirror units (1) are stacked one on top of the other, with contacting only of their end panels (10), in such a manner that the engagement means (12) of the first longitudinal edges (11) of the end panels (10) interact with the counter-engagement means (14) of the second longitudinal edges (13) of adjacent end panels (10).

8. The method according to claim 7, wherein a lowermost mirror unit (1) is inserted into longitudinal slots (21) of two parallel-offset base rails (20) with the first or second longitudinal edges (11, 13) of the end panels (10) assigned to it, which rails are elevated on stand elements (24), in each instance.

9. The method according to claim 8, wherein the base rails (20) are first covered with a first layer composed of mirror units (1) alternately rotated by 180°, and then similar further layers are laid on top, wherein adjacent end panels (10), in each instance, engage into one another at the longitudinal edges (11, 13) and upright edges (17), using their engagement means (12, 18) and counter-engagement means (14).

10. The method according to claim 7, wherein the transport unit (8) is dismantled at the installation site by means of a crane apparatus, wherein the mirror units (1) are individually lifted up, layer by layer, and set down onto a support apparatus (4) for installation of the mirror units (1), wherein the support apparatus (4) has a rail arrangement (6) assigned to it, using which mirror units (1) delivered on the support apparatus (4) in the end position are moved to their installation position.

11. The method according to claim 10, wherein the end panels (10) are moved on the rail arrangement (6) and only removed at the installation position.

12. The method according to claim 10, wherein the end panels (10) are removed after the mirror units (1) are set down onto the support apparatus (4), and the units are moved to their installation position along the support apparatus (4) using carriages (7).
